(19) United States
(12) Patent Application Publication
(10) Pub. No.: US 2004/0217718 A1
(43) Pub. Date: Nov. 4, 2004

(54) Digital addressable electronic ballast and control unit

(76) Inventors: Russikesh Kumar, Whitehall, PA (US); Donald Ray Mosebrook, Coopersburg, PA (US); Matthew Skvoretz, Emmaus, PA (US); Michael A. Zientara, Macungie, PA (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/833,663

(22) Filed: Apr. 28, 2004

Related U.S. Application Data
(60) Provisional application No. 60/467,716, filed on May 2, 2003.

(51) Int. Cl. H05B 37/02

(52) U.S. Cl. 315/291; 315/224

(57) ABSTRACT

Systems and methods for providing a load control device, such as a DALI ballast, having an infrared receiver. The load control device resides on a digital communications link and receives infrared commands via a lightpipe. The commands are input to a microprocessor to set an address of the load control device. Addressing the load control device in this manner allows plural control devices residing on a single communications link to be addressed by the same short address. The control devices may be removed and replaced, and the short address and zone assignments of the removed devices may be reassigned to the replacement devices via infrared communication. The load control device may be placed into various modes (e.g., a programming mode or addressing mode) via commands received over the infrared receiver.

### CROSS-REFERENCE TO RELATED APPLICATION

The present application claims priority to U.S. Provisional Patent Application No. 60/467,716, filed May 2, 2003, which is incorporated herein by reference in its entirety.

### FIELD OF THE INVENTION

This invention relates to lighting systems and lighting system control units. Specifically, the present invention relates to a DALI (Digital Addressable Lighting Interface) lighting system that includes DALI master lighting control units and DALI ballasts. The DALI protocol is set out in technical standard IEC 60929 under Annex E, which is maintained by the International Electrotechnical Commission.

### BACKGROUND OF THE INVENTION

Adopting the DALI standard has a number of benefits over other existing ballast control methods such as 0-10V or phase control. Some of the benefits of utilizing the DALI standard are that only a single control link is necessary for all ballasts. In addition, ballasts can be assigned a soft address to follow specific zones or groups and the ballasts can be re-zoned to suit any floor plan changes without rewiring.

Known products for controlling DALI ballasts, such as Lutron GRAFIK Integrale™ (GXI) and Ten Volt Module (TVM), use a broadcast-only method, i.e., the ballasts are not uniquely addressed. A drawback of this method is that any ballast connected to the control link will follow the intensity transmitted by the master lighting control unit. Another drawback is that multiple zones require multiple data links to be run.

Other products provide the ability for users to control individual ballasts. These systems provide this ability by addressing individual ballasts and do not require separate control lines for each zone. However, these systems are difficult to manage because they require a personal computer (PC) and software to carry out the initial set-up or future rezoning of the system. One method for addressing the ballasts involves randomly assigning addresses to the ballast on the control link, which adds to confusion and difficulty when attempting to identify a ballast in the installation space by the address number. Another method requires removing a lamp in the fixture that the ballast is installed in. The ballast will then determine that a lamp disconnected. If a lamp is removed from only one fixture at a time, the ballast connected to that lamp can be uniquely identified and a unique address can be sent across the control link to the ballast. This method is tedious and requires that the installer has access to each lighting fixture.

Thus, prior art systems lack a simple solution or device for controlling the lights and carrying out all initial system setup as well as system rezoning. Accordingly, there is a need for a lighting control system that provides a simple user interface that may be used to quickly and easily rezone lighting systems. The present invention provides such a solution.

### SUMMARY OF THE INVENTION

The present invention is directed to systems and methods for controlling and addressing DALI ballasts having an infrared receiver. The present invention simplifies the process of setting up, using and rezoning a DALI lighting control system. In particular, all ballasts may communicate via a single data link and all initial ballast address assignments can be made without the use of a computer or any other programming device. Further, ballasts may be assigned and reassigned to a zone in an intuitive fashion.

In accordance with a feature of the invention, there is provided an electronic ballast for driving a gas discharge lamp. The ballast includes an inverter circuit for producing a high frequency drive voltage to drive a lamp current in the gas discharge lamp, a controller that is coupled to the inverter circuit, a digital communication port that is coupled to the controller and operable to be connected to a digital communication link, an infrared communication port that is coupled to the controller and operable to receive a signal representative of an infrared data signal transmitted from an infrared transmitter, and a memory that is coupled to the controller and operable to store an address of the ballast. The address uniquely identifies the ballast on the digital communication link and the signal representative of the infrared data may include the address and the controller is operable to store the address in the memory.

According to a feature of the invention, the signal representative of the infrared signal may include a first command and the controller is operable to cause the ballast to enter a programming mode upon receipt of the first command. The controller may be operable to cause the inverter circuit to flash the lamp at a first rate after the ballast has entered the programming mode. The controller may be operable to receive a second command from the signal representative of the infrared data signal to cause the ballast to enter an addressing mode. In addition, the controller may be operable to cause the inverter circuit to flash the lamp at a second rate after the ballast has entered the addressing mode. The controller may be operable to receive a third command from the signal representative of the infrared data signal to cause the ballast to exit from the programming mode.

According to another feature, the infrared communication port may comprise an infrared receiver. In addition, a lightpipe may be provided for facilitating the transmission of the infrared data signal from the infrared transmitter to the infrared receiver. The lightpipe may be manufactured from a polyurethane tube or a THV terpolymer tube. A lens may be provided for facilitating the transmission of the infrared data signal from the infrared transmitter to the infrared receiver.

According to yet another feature, the infrared communication port may be operable to receive a control signal from an infrared receiver external to the ballast, where the control signal is representative of the infrared data signal.

According to another feature, the digital communication link may be a DALI communication link.

According to another aspect of the invention, there is provided a lighting control system that includes an infrared transmitter that operable to transmit an infrared data signal, a digital communication link, a load control device coupled to the digital communication link, and comprising a memory for storing an address. The load control device is operable to receive a signal representative of the infrared data signal comprising the address and store the address in the memory.

This aspect of the present invention may include features noted above. In addition, according to other features, a plurality of control devices may be connected to the digital communication link and the address of the load control device is unique between all load control devices on the digital communication link. Also, a plurality of control devices may be connected to the digital communication link and the multiple load control devices on the digital communication link are operable to have an identical address.

According to yet another aspect of the invention, there is provided a method of setting a link address for a device in communication with a control link from an infrared transmitter via infrared communication. The method includes transmitting the link address from the infrared transmitter to the device, and storing the link address in a memory of the device.

According to a feature, the method may include causing the device to enter a programming mode by sending a first command from the infrared transmitter to the device, prior to transmitting the link address from the infrared transmitter to the device. The device may be operable to control a lighting load and the method may also include causing the device to flash the lighting load at a first rate after the device has entered the programming mode. Further, the method may include causing the device to enter an addressing mode by sending a second command from the infrared transmitter to the device, after the device has entered the programming mode. The device may flash the lighting load at a second rate after the device has entered the addressing mode. Pressing one of the plurality of buttons may select the link address to be transmitted from the infrared transmitter to the device. Exiting the programming mode may be performed by sending a third command from the infrared transmitter to the device.

According to another feature, the infrared transmitter may include a user interface having a plurality of buttons such that simultaneously pressing and holding two of the plurality of buttons for a predetermined period of time will send the either the first or third command. Pressing one of the plurality of buttons will send the second command. A plurality of devices may be connected to the control link and the link address is transmitted to at least two of the plurality of control devices.

According to yet another aspect of the invention, there is provided a method of addressing a device in communication with a control link. The method includes causing the device to select a random address that is significantly larger than the maximum number of devices possible to be in communication with the control link, ascertaining the random address of the device by performing a binary tree search method of the universe of possible random addresses, transmitting to the device at the random address a short address up to the maximum number of devices possible to be in communication with the control link, and storing the short address in a memory in the device.

According to a feature of the invention, a plurality of devices are in communication with the control link and the binary tree search method includes ascertaining if the random address of the device is within a subset of possible random addresses, reducing the subset of possible random addresses and repeating previous steps.

According to another aspect of the invention, there is provided a method of assigning a device to a group from the user interface of a master lighting control unit, wherein both the device and the master lighting control unit are in communication with a control link. The method includes selecting the device using the user interface of the master lighting control unit, assigning the device to the group, and storing this assignment in a memory of the master lighting control unit.

According to a further aspect of the invention, there is provided a master lighting control unit that includes a controller, a user interface coupled to the controller, a digital communication port coupled to the controller and operable to be connected to a digital communication link having a control device also connected thereto; the control device having an address, and a memory coupled to the controller and operable to store the address of the control device. The controller is operable to cause the control device to choose a random address that is significantly larger than the maximum number of devices possible to be in communication with the digital communication link, ascertain the random address of the control device by performing a binary tree search method of the universe of possible random addresses, and transmit to the control device at the random address a short address up to the maximum number of devices possible to be in communication with the digital communication link.

According to yet another aspect of the invention, there is provided a master lighting control unit that includes a controller, a user interface coupled to the controller, a digital communication port coupled to the controller and operable to be connected to a digital communication link having a control device also connected thereto and having an address, and a memory coupled to the controller and operable to store the address of the control device. The controller is operable to select the address of the control device, assign the device to a group, and store this assignment in the memory.

Additional features and advantages of the invention will be made apparent from the following detailed description of illustrative embodiments that proceeds with reference to the accompanying drawings.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention where like elements have like reference numerals; however, the invention is not limited to the specific methods and instrumentalities disclosed. In the drawings:

FIG. 1a illustrates an exemplary lighting control system having DALI ballasts;

FIG. 1b illustrates a block diagram of an exemplary master lighting control unit;

FIG. 1c shows the user interface of an exemplary master lighting control unit;

FIG. 2 is a flow chart of a process for addressing a plurality of devices on a control link;

FIG. 3 is a flow chart of a process of assigning a plurality of devices on a control link to a specific group or zone;

FIG. 4a illustrates a first embodiment of the DALI Ballast having an infrared (IR) receiver;

FIG. 4b illustrates a second embodiment of the DALI Ballast;

FIG. 4c shows an embodiment of IR transmitter;

FIG. 5 is a flowchart of the method for setting the link address of a plurality of devices on a control link using IR communication; and

FIG. 6 is a flowchart illustrating the processing of DALI commands.

### DETAILED DESCRIPTION OF ILLUSTRATIVE EMBODIMENTS

The master lighting control unit of the present invention provides a simplified process of setting-up, using and rezoning a DALI lighting control system. In accordance with the present invention, all ballasts may be on a single digital communication link, and all initial ballast address assignments may be carried out without the use of a computer or any other programming device. The master lighting control unit provides for an intuitive manner by which ballasts may be assigned to a zone. In addition, sensors, such as occupancy sensors, may be connected directly to the communication link and assigned to control one or more zones.

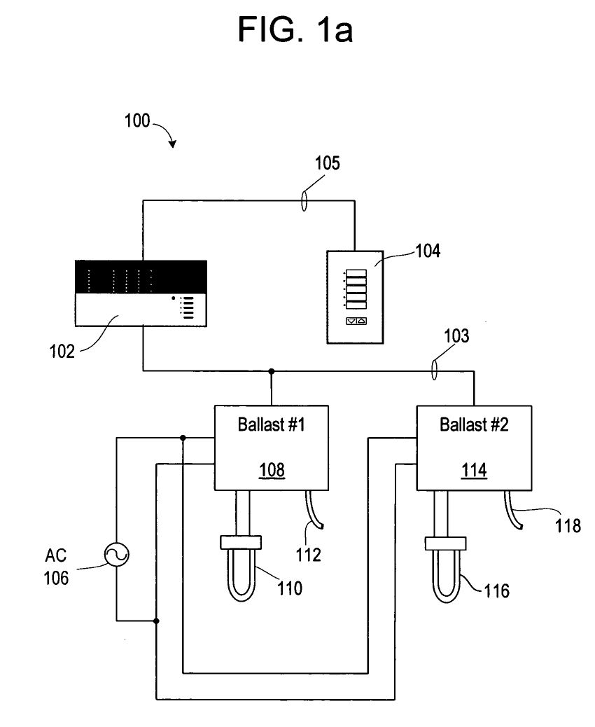

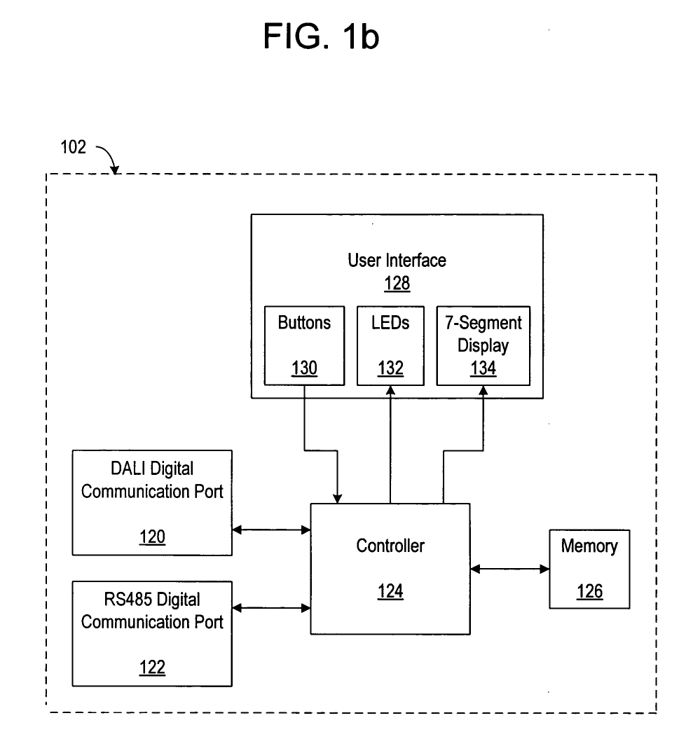

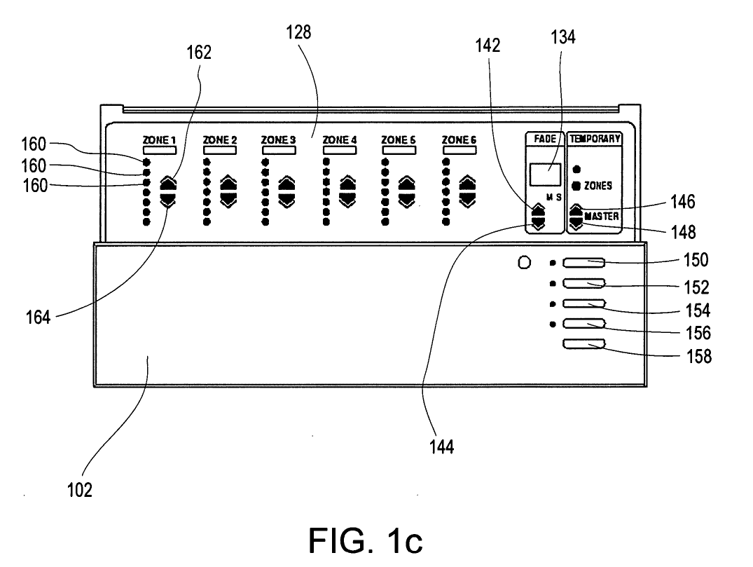

Referring now to FIG. 1a, there is illustrated an overview of an exemplary system 100 including a DALI master lighting control unit 102, a wallstation 104, an RS485 communications link 105, and two DALI ballasts 108 and 114 in accordance with the present invention. The DALI ballasts 108 and 114 drive lamps 110 and 116, respectively. As will be discussed below, the lightpipes 112 and 118 are flexible plastic tubes for conducting infrared (IR) signals to an IR receiver included with each of the DALI ballasts. The master lighting control unit 102 communicates with the ballasts over a DALI control link 103. Ballasts 108 and 104 are powered by AC (alternating current) source 106.

Referring to FIG. 1b, a block diagram of an exemplary master lighting control unit 102, having a controller 124. A DALI digital communication port 120 and an RS485 digital communication port 122 allows for communication with the DALI control link 103 and the RS485 communication link 105 respectively. A memory 126 stores system data such as ballast addresses. The user interface 128 of the master lighting control unit 102 has several buttons 130 for user input and multiple LEDs 132 and two seven-segment displays 134 for feedback to the user.

The user interface 128 of the master lighting control unit 102 is similar to the user interface on the GRAFIK EYE control unit available from Lutron Electronics Co., Inc. of Coopersburg, Pa. and is shown in FIG. 1c. A first, second, third, fourth, and fifth scene buttons 150, 152, 154, 156, 158 are used to select lighting presets (or scenes) as well as enter and exit programming mode. Seven-segment display displays 134 provide feedback of, for example, the address of the currently selected DALI ballast 108 or the mode of the master lighting control unit 102. A fade raise button 142, a fade lower button 144, a master raise button 146, and a master lower button 148 are provided for user inputs during normal operation and programming. A zone raise (or zone assign) button 162 is used to raise the intensity of a zone of lights during normal operation and to assign a ballast 108 to a zone of the master lighting control unit 108 while in programming mode. A zone lower (or zone unassign) button 164 is used to lower the intensity of a zone of lights during normal operation and to unassign a ballast 108 from a zone of the master lighting control unit 108 while in programming mode. Zone LEDs 160 provided feedback of zone intensity during normal operation or of selected zones during programming. The operation of the buttons and LEDs of user interface 128 during programming is explained in further detail below.

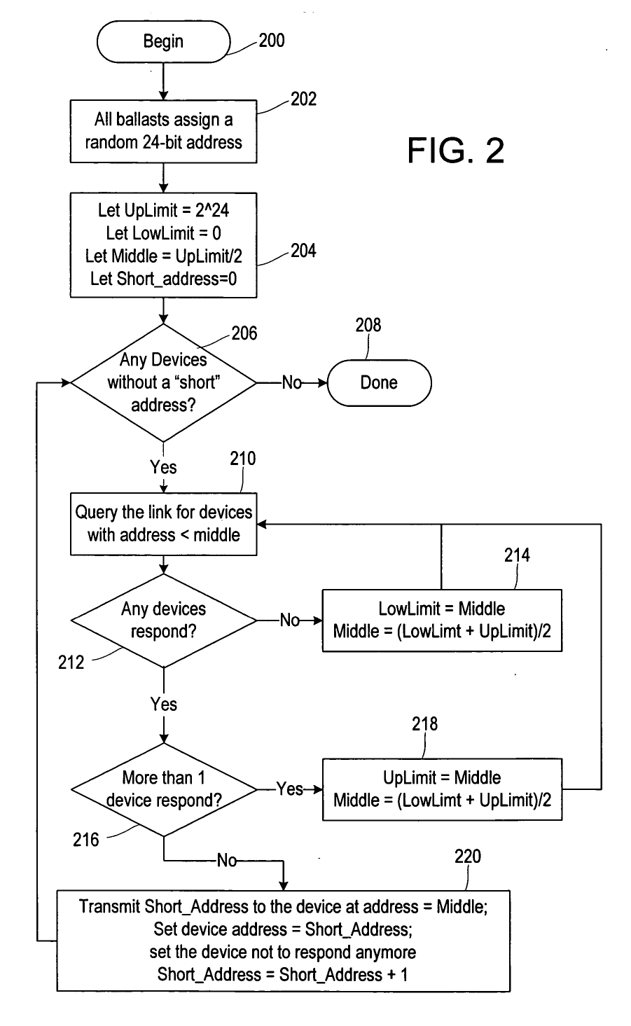

The master lighting control unit 102 assigns each ballast a short address (e.g., between 1-64), which is used to communicate with the DALI ballast in accordance with the DALI protocol. During an initialization process (described below with reference to FIG. 2), the master lighting control unit 102 commands all ballasts 108 and 114 to choose a random 24-bit address. Next, the master lighting control unit systematically assigns each ballast 108, 114 its unique short address. Assigning each ballast an individual short address limits the link 103 to only 64 ballasts. However, in accordance with the present invention, ballasts can also be individually addressed via IR communication, thus overcoming the limitation of 64 ballasts on the link, if necessary. Note that the short address may the “link” address.

The master lighting control unit 102 allows the installer or lighting designer to assign each ballast to a zone on the master lighting control unit. The master lighting control unit 102 will allow the ballasts to be assigned to up to 16 zones. It is noted that as used herein, the term “zone” corresponds to a “group” in accordance with the DALI protocol. Still further, the master lighting control unit 102 will allow up to 4 sets of occupancy sensors to be connected without the need for interfaces and the sensors may control one or more of the zones. The master lighting control unit 102 provides for ballast replacement by storing a ballast map in the non-volatile memory 126. Once configured, the master lighting control unit 102 further allows users to select scenes from the front of the unit by using the scene buttons 150, 152, 154, 156, 158 or from wallstations 104, and the user will be able to adjust scene levels using the zone raise and lower buttons 162, 164. A fade time between scenes can also be set and the master lighting control unit 102 may address other system components.

Referring now to FIG. 2, there is illustrated a flow chart of a method for addressing a plurality of devices on a control link. The process is performed as a binary tree search and begins at step 200. At step 202, an initialization process begins wherein all ballasts assign themselves a random 24-bit address. It is preferable that each device assign itself a random address that is significantly larger than the total number of devices on the link. “Significantly larger” means at least 1024 (2\hat{ }10) times larger than the maximum number of short address possible on the control link, which in this case, is at least 65536 (2\hat{ }16) meaning a 16-bit number. At step 204, upper (UpLimit) and lower (LowLimit) limits of the address search space are set. For example, UpLimit is set to the maximum 24-bit address, which is 2²⁴ and LowLimit is set to 0. The middle of the address space is determined by dividing the upper limit by 2 (UpLimit/2). A value of the short address (Short_address) is also initialized to 0.

At step 206 the master lighting control unit determines if any devices that are connected to the system have yet to be assigned a short address. If all devices have been assigned short address, then the process ends at step 208. If there are devices that need a short address, then at step 210, the link is queried for ballasts having an address less than a middle address between the lower limit and the upper limit set at step 204. Next, at step 212, it is determined if any devices have responded to the query. If no devices responded, the lower limit value is changed to the middle address value determined at step 204 and a new middle address value is determined. The process returns to step 210 using the new middle address value. If devices responded at step 212, then it is determined at step 216 if more than one device responded. If only one device responded, then at step 220, a short address is assigned to the device, and the device is set not to respond to any further inquiries. In accordance with the DALI protocol, the unique short address is a value between 0 and 63 that may be stored in memory in the ballast. At this step, the short address value is also incremented by one after being assigned to a ballast. The process returns to step 206 to search for any additional devices that are without a short address. If more than one device responded at step 216, then the upper limit value is changed to the middle address value determined at step 210 and a new middle address value is determined. The process returns to step 210 using the new middle address value. The process of FIG. 2 for addressing the devices on the DALI link is provided merely for exemplary purposes, as other processes may be used.

The two-way communication on a DALI link 103 allows the master lighting control unit 102 to request the status of each ballast in a round robin fashion in order to detect failed ballasts or lamps. This will check for lamp burn-out or for failed ballasts. No reply from an address indicates that a ballast has failed or is unpowered. This check also allows for Emergency Modes. For example, if certain groups of ballasts fail or lose power, other ballasts can be set to their emergency intensity levels to compensate.

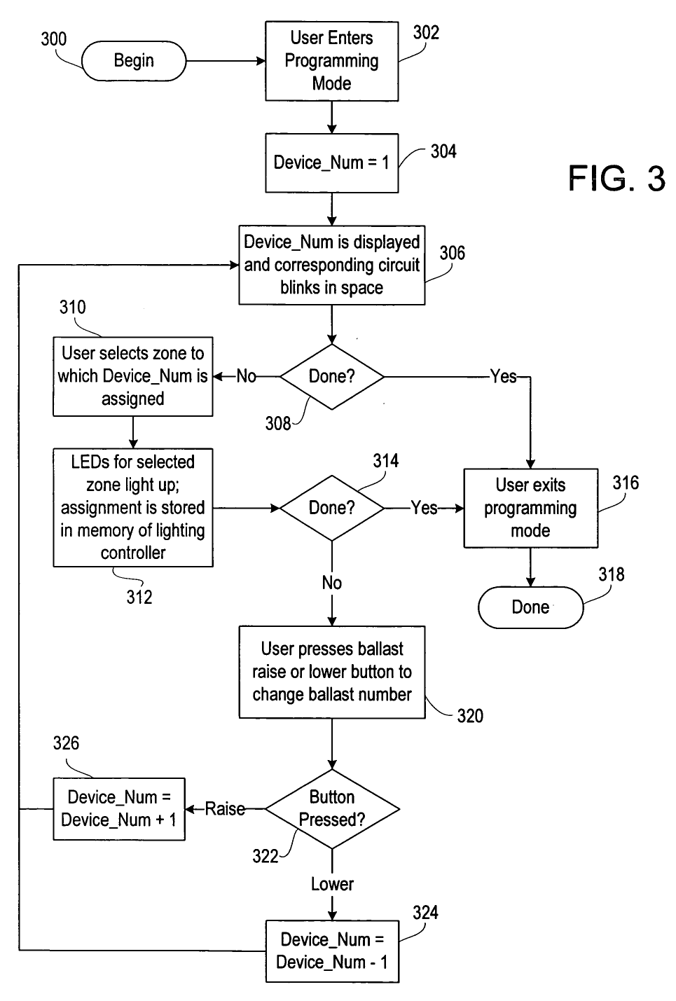

If ballasts fail and are replaced, the new ballasts need to be re-addressed. This is achieved by invoking the initialization process of step 202 to generate new random addresses for all ballasts. Only the new ballasts without a short address will respond to the search and addressing process that begins at step 206. Once found, these ballasts will be assigned the short addresses that have not been responding during the detection of failed ballasts. If only one ballast has failed, the zone assignment (see, FIG. 3 below) will also be assigned to the ballast automatically otherwise the user will need to assign the new ballasts to the correct zone. The user will be able to reassign the ballast if the zone assignment is incorrect. In addition, ballasts equipped with an IR receiver can be addressed and assigned to zones using the IR transmitter described below.

Referring now to FIG. 3, the process of assigning a plurality of devices on a control link to a specific group or zone from a master lighting control unit will now be described. Generally, a user steps through each device on the control link from the user interface of the master lighting control unit, assigns each device to a group, and then stores this assignment in memory in the master lighting controller unit.

The flowchart provided in FIG. 3 further details this operation and is one possible implementation of the method of assigning the devices on the DALI link to zones (or groups) in the lighting control system. The user begins at step 300 and enters the “Programming mode” at step 302 by pressing a combination of buttons on the user interface 128 of the master lighting control unit 102. For example, the user might press and hold the first scene button 150 and the fifth button 158 simultaneously for a few seconds to enter “Programming” mode. Next, at step 304, the ballast at short address 1 is selected to begin the process. At 306, since the ballast with short address 1 is selected, the number “1” is displayed on a seven segment displays 134 of the master lighting control unit 102 and the fluorescent load (e.g., lamp 110) at the short address 1 flashes in the job space so that the user can visually determine which ballast is at this address. The rate at which the lamp flashes is preferably 1 blink every 2 seconds. If at step 308, the user is not completed assigning ballasts to specific zone, then at step 310, the user chooses a zone to which the first ballast (i.e., the ballast at short address 1) will be assigned by pressing a zone raise button 162 on the user interface 128 corresponding to the zone that the user desires to assign the ballast to. At step 312, the zone LEDs 160 for the selected zone may light up on the user interface 128 and the assignment of the ballast to the zone is stored in memory in the master lighting control unit 102. At steps 314, 320, 322, 324 and 326, if the user desires to program additional ballasts on the control link, the user presses the master raise button 146 to move to the next higher ballast on the DALI control link 103 or the master lower button 148 to move to the next lower ballast on the DALI control link 103. The user then repeats the assignment process above. If the user is completed at step 314 or step 308, the user can select to exit the programming mode at 316. For example, the user might press and hold the first scene button 150 and the fifth button 158 simultaneously for a few seconds to exit “Programming” mode. To reassign any ballast or sensor to a new zone, the DALI Zone Assignment process is repeated for that ballast address or sensor input.

Although the DALI protocol is very extensive in operation, it has no provisions for addressing a ballast without the need of a master DALI controller (i.e., a controller to send commands to the ballast over a DALI link). The present invention overcomes this limitation by using a ballast with IR receiving capabilities and a process for addressing ballasts through incoming IR commands.

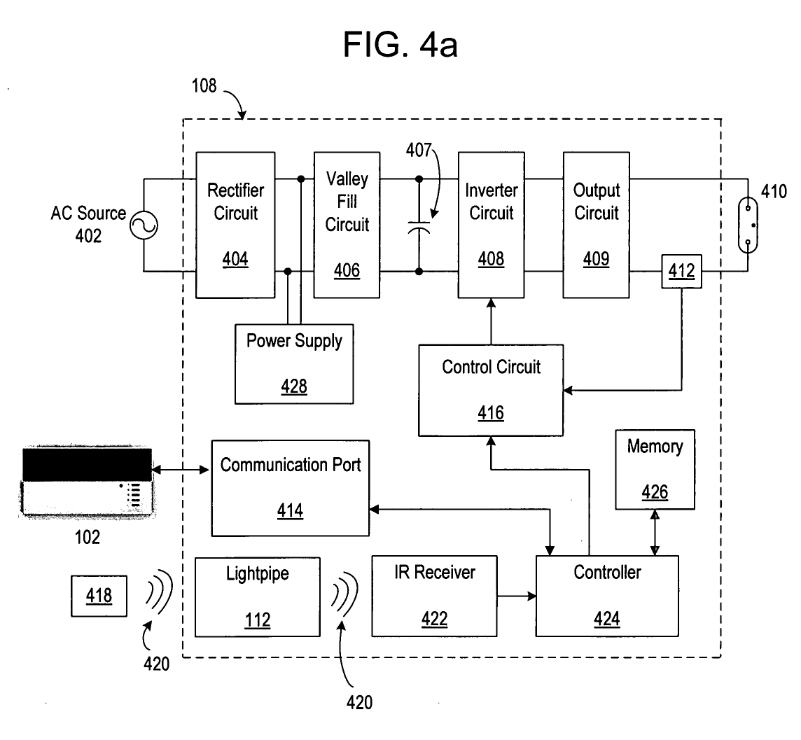

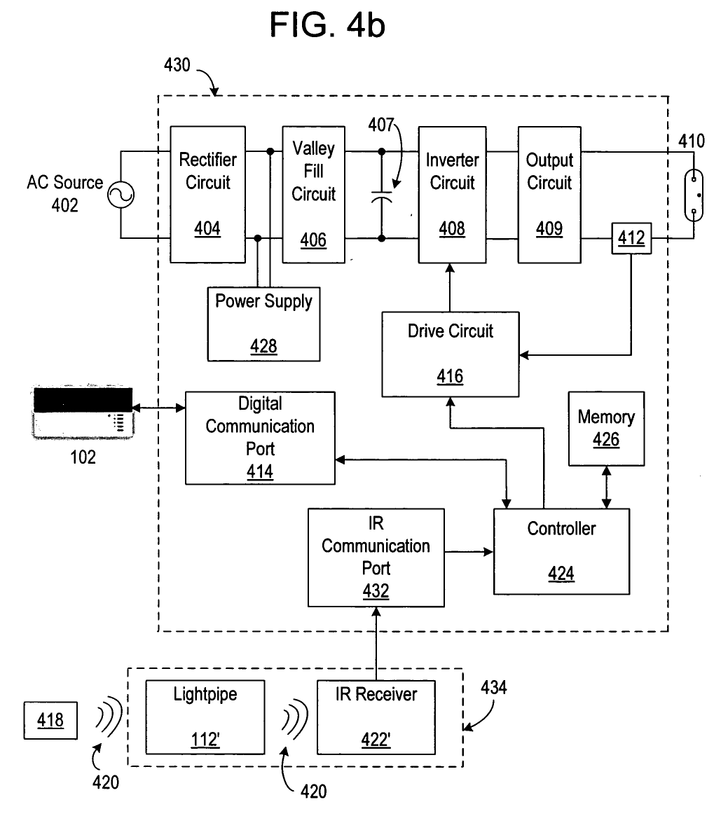

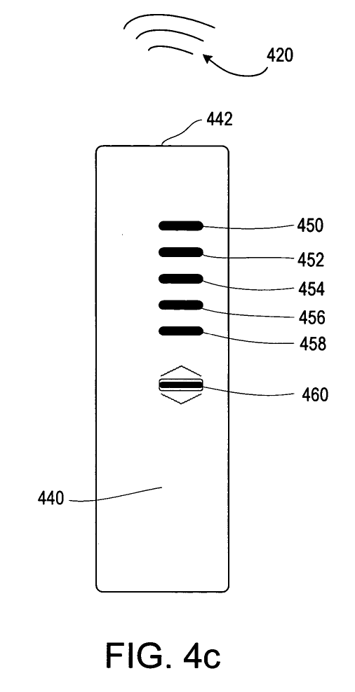

FIG. 4a illustrates a simplified block diagram of an exemplary DALI Ballast (e.g., ballast 108) with an IR receiver 422 in accordance with the invention. The DALI ballast 108 includes a rectifying circuit 404 capable of being connected to an AC power supply 402 which provides an AC line voltage with a given line frequency (typically 50 Hz or 60 Hz). The rectifying circuit 404 converts the AC line voltage to provide a full wave rectified voltage. The rectifying circuit 404 is connected to a valley fill circuit 406. The valley fill circuit 406 selectively charges and discharges an energy storage device so as to create a valley filled voltage. A high frequency bypass capacitor 407 is connected across the output terminals of the valley fill circuit 406. The output terminals of the valley fill circuit 406 are in turn connected to the input terminals of an inverter circuit 408. The inverter circuit 408 converts the valley filled voltage to a high-frequency AC voltage. The output terminals of the inverter circuit 408 are connected to an output circuit 409, which typically includes a resonant tank. The output circuit 409 filters the output of inverter circuit 408 to supply essentially sinusoidal high frequency voltage, as well as provides voltage gain and increased output impedance. The output circuit 409 is capable of being connected to drive a load 410 such as a gas discharge lamp; for example, a fluorescent lamp. An output current sense circuit 412 coupled to the load 410 provides load current feedback to a drive circuit 416. The drive circuit 416 provides control signals to control the operation of the inverter circuit 408 so as to provide a desired load current to the load 410. The drive train of the ballast 108 is described in further detail in U.S. patent application Ser. No. 10/006,036 entitled “Single Switch Electronic Dimming Ballast”.

The lightpipe 112 receives and directs IR radiation 420 from an IR transmitter 418 to an IR receiver 422. Preferably, the lightpipe 112 comprises an ester based polyurethane tube, e.g., made of TYGOTHANE manufactured by Norton Plastics of Akron, Ohio as described in U.S. Pat. No. 5,987,205. The lightpipe has a malleable rod disposed in the hollow tube to allow the hollow tube to be bent into a configuration. Alternatively, the lightpipe may be made of a tetrafluoreoethylene hexafluoropropylene and vinylidene fluoride (THV) terpolymer, however, other suitable substitutes may be used. It should be noted that instead of a lightpipe, an optical lens could be used to facilitate the transmission of the IR radiation 420 from the IR transmitter 418 to the IR receiver 422.

The IR receiver 422 decodes IR commands from the IR transmitter 418 and inputs the decoded command to a controller 424 within the DALI ballast 108. In addition, the controller 424 may transmit DALI commands to the master lighting control unit 102 and receive DALI commands from the master lighting control unit 102 via communication port 414. In response to inputs from either the IR receiver 422 or communication port 414, the controller 424 outputs a signal to the drive circuit 416, which in result drives the inverter circuit 408 accordingly. A memory 426 is provided to store the address of the ballast 108. A power supply 428 is connected across the output terminals of the rectifying circuit 404 and provides the necessary power for operation of the communication port 414, drive circuit 416, IR receiver 422, and controller 424. The controller 424 is preferably a microprocessor, but can be any sort of processing unit, such as an ASIC (Application-Specific Integrated Circuit) or a PLD (Programmable Logic Device). Note that the master lighting control unit 102, AC source 402, lamp 410, and IR transmitter 418 are not part of the DALI ballast 108.

FIG. 4b illustrates a simplified block diagram of a second embodiment of a DALI ballast 430 in accordance with the invention. Here, the lightpipe 112′ and the IR receiver 422′ are housed in an enclosure 434 external to the ballast 430. The IR receiver 422′ decodes IR commands from the IR transmitter 418 and inputs the decoded command to IR communication port 432 in the ballast 430. The IR communication port 432 simply routes the decoded command from the IR receiver 422 to the controller 424 within the DALI ballast 430. The same signal is communicated between the IR receiver 422′ in enclosure 434 and the controller 424 as was communicated between the IR receiver 422 and the controller 424 in the previous embodiment. As with lightpipe 112, the lightpipe 112′ comprises an ester based polyurethane tube, e.g., made of TYGOTHANE, while a THV terpolymer or other suitable substitute may be used. It should be noted that instead of a lightpipe, an optical lens could be used to facilitate the transmission of the IR radiation 420 from the IR transmitter 418 to the IR receiver 422′. All other blocks function as described above in the ballast 108 in FIG. 4a.

FIG. 4c shows an embodiment of IR transmitter 440. A first button 450, a second button 452, a third button 454, a fourth button 456, a fifth button 458 and a raise/lower rocker 460 are provided. The IR data signals 420 are emitted from the top end 442 of the IR transmitter 440.

The present invention provides a novel method for assigning the short address of devices such as DALI ballast 108, as well as assigning zones and other settings, using IR communications. Generally, the process for setting the short address of a plurality of devices on a control link using IR communication includes causing a first device (e.g., a DALI ballast or other device) to enter a programming mode by sending a command from an IR transmitter to the first device; transmitting a short address (up to the total number of devices on the link, preferably 1-64) to the first device through IR communication; storing the short address in a memory of the first device; causing the first device to exit programming mode by sending a command from an IR transmitter to the first device; and repeating the above steps for all devices on the control link.

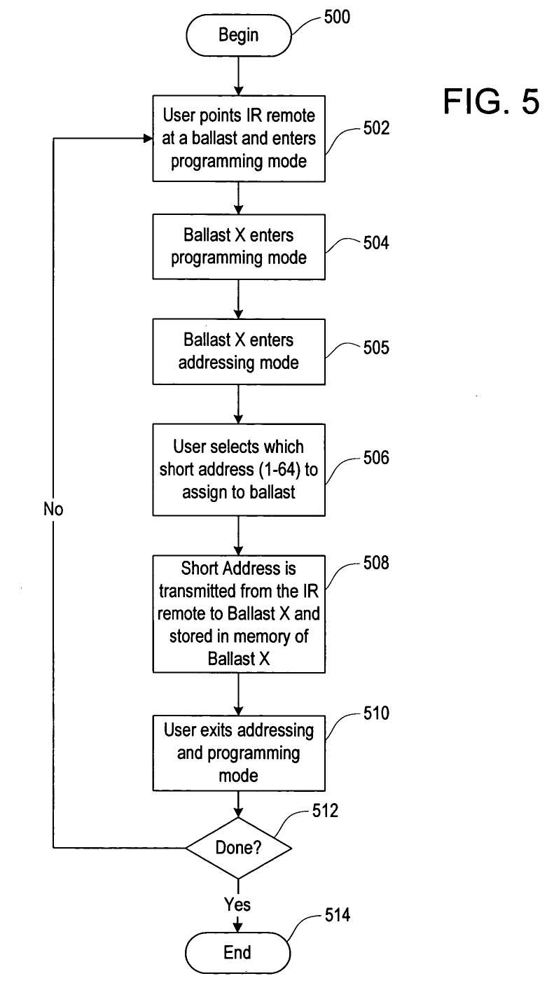

FIG. 5 further details the process described above. At step 500 the process begins for addressing the devices on a control link using IR communications. At step 502, to begin the addressing process, the user points an IR transmitter at a fluorescent fixture, which has a ballast with an internal or external IR receiver. The IR lightpipe protrudes through the fixture so that the user in the space is able to send IR commands to the ballast. At step 504, the user enters “Programming” mode of the selected ballast by entering the appropriate command at the IR transmitter. For example, the user might press and hold the first button 450 and the fifth button 458 on IR transmitter 440 simultaneously for a few seconds to enter “Programming” mode. At this point, the lamps connected to the selected ballast will flash as an indication that the selected ballast is in “Programming” mode. At step 505, the user then enters the “Addressing” mode by entering the appropriate command at the IR transmitter 418. For example, the user might press the raise/lower rocker 460 on IR transmitter 440 up to enter “Addressing” mode. Now, the lamps connected to the selected ballast will flash at a faster rate as an indication that the selected ballast is in “Addressing” mode. At step 506, the user inputs a short address, up to the total possible number of ballasts on the link. Using the IR transmitter 440, the user has the choice of inputting address 0 by pressing the first button 440, address 1 by pressing the second button 442, address 2 by pressing the third button 444, address 3 by pressing the fourth button 446, and address 4 by pressing the fifth button 448. Of course, the user is limited to only choosing 5 addresses by using the IR transmitter 440. However, with a more advanced transmitter having additional buttons, the user would be able to choose between all 64 short addresses possible on the control link. At step 508, the address selected in step 506 is transmitted to the ballast via IR communication and stored in memory in the ballast and “Addressing” mode is exited. After the address is selected, the ballast will signify that the address has been changed by quickly fading the lamp down to an extreme light level, pausing, fading to the other extreme light level, pausing, and then fading to midrange. At step 510, the user exits “Programming” mode and repeats the above steps for the next ballast until done. For example, the user might press and hold the first button 450 and the fifth button 458 on IR transmitter 440 simultaneously for a few seconds to exit “Programming” mode. In accordance with the present invention, the IR transmitter control may be standard remote with buttons or a PDA (Personal Digital Assistant). In accordance with FIG. 5, it is noted that the protocol used does not have to be the DALI protocol and that the controlled devices do not need to be ballasts.

The above implementation is advantageous in that it avoids randomly assigning the short addresses to the ballasts, which adds to confusion and difficulty when identifying a ballast in the space by the address number. By using IR communication, the short addresses can be assigned in a logical manner, providing for ease in setup of the system. Since two devices can be assigned the same short address, more than 64 ballasts can be connected to the control link. The present invention also overcomes another problem of a previous addressing technique, as lamps do not need to be removed from the fixture of a ballast before programming the address of the ballast. By addressing the ballast via IR communication, the need to gain access to the lighting fixture to remove a lamp in order to assign the ballast an address is also avoided.

Another advantage of this implementation is that it allows for the addition of new features. For example, this method could be used to program other characteristics via IR communication, such as the ballast group, maximum lighting level, minimum lighting level, default intensity level, scene levels, fade times, and fade rates. Also, if the IR communication system operates with two-way communication, the ballast could transmit the current operational characteristics and diagnostic feedback for display at the IR transmitter.

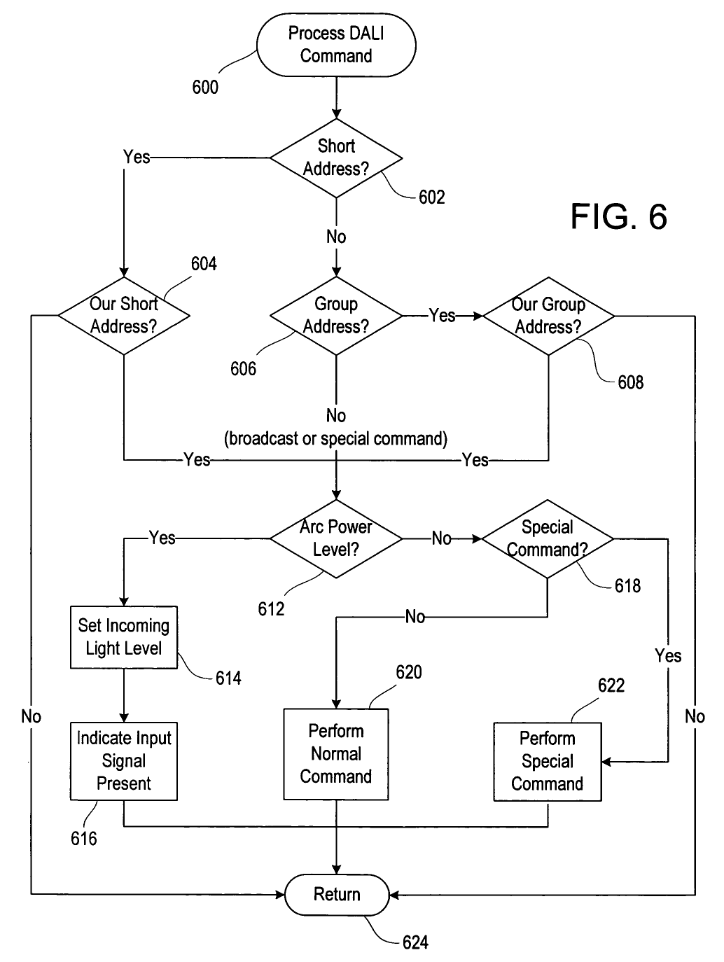

The reading of DALI commands is interrupt based. An interrupt handler processes the rising or falling edge and recreates the incoming DALI command bit by bit. Once the commands are read in and recreated, they are then processed as illustrated in FIG. 6 beginning at step 600. At steps 602, 604, 606 and 608, the received address is checked to see if it pertains to a ballast address. The types of addresses possible are short addresses (individual ballasts), group addresses (groups of ballasts), and broadcast (all ballasts). For example, after the address has been checked at steps 602 and 604 for a recognized short address, or at steps 606 and 608 for a recognized group address, if the received command does not pertain to a ballast then the processing stops at step 624.

If the address is directed to a ballast, then the received command needs to be processed at steps 612-622. The types of commands possible are arc-level commands (instruction to change to arc-power light level), normal commands (basic set of commands that do not need parameters such as turn off, fade up, etc.), and special commands (the set of commands that do need parameters such as storing values, storing addresses, etc.). After the command is processed the routine exits at step 624.

In addition to the DALI protocol, the ballast may be able to incorporate more features not required or specified in the DALI standard. The most obvious feature is IR addressing so that individual ballasts can be addressed without the need of a master lighting control unit. While the DALI ballast and DALI master lighting control unit described above are using the DALI protocol to communicate on the digital communication link, it should be noted that the disclosed ballast, master lighting control unit, and methods apply to any digital link having devices having digital addresses.

While the present invention has been described in connection with the preferred embodiments of the various Figs., it is to be understood that other similar embodiments may be used or modifications and additions may be made to the described embodiment for performing the same function of the present invention without deviating therefrom. Furthermore, it should be emphasized that a variety of computer platforms, including handheld device operating systems and other application specific operating systems are contemplated. Still further, the present invention may be implemented in or across a plurality of processing chips or devices, and storage may similarly be affected across a plurality of devices. Therefore, the present invention should not be limited to any single embodiment, but rather should be construed in breadth and scope in accordance with the appended claims.

What is claimed:

1. An electronic ballast for driving a gas discharge lamp, comprising:
an inverter circuit for producing a high frequency drive voltage to drive a lamp current in said gas discharge lamp;
a controller, coupled to said inverter circuit for control of said inverter circuit;
a digital communication port, coupled to said controller and operable to be connected to a digital communication link;
an infrared communication port, coupled to said controller and operable to receive a signal representative of an infrared data signal transmitted from an infrared transmitter; and
a memory, coupled to said controller and operable to store an address of said ballast;
wherein said signal representative of said infrared data comprises said address and said controller is operable to store said address in said memory; and
wherein said address identifies said ballast when said ballast is connected to said digital communication link.

2. The electronic ballast of claim 1, wherein said signal representative of said infrared signal comprises a first command and said controller is operable to cause said ballast to enter a programming mode upon receipt of said first command.

3. The electronic ballast of claim 2, wherein said controller is operable to cause said inverter circuit to flash said lamp at a first rate after said ballast has entered said programming mode.

4. The electronic ballast of claim 3, wherein said signal representative of said infrared signal comprises a second command and said controller is operable to cause said ballast to enter an addressing mode upon receipt of said second command.

5. The electronic ballast of claim 4, wherein said controller is operable to cause said inverter circuit to flash said lamp at a second rate after the ballast has entered said addressing mode.

6. The electronic ballast of claim 5, wherein said second rate is faster than said first rate.

7. The electronic ballast of claim 5, wherein said signal representative of said infrared signal comprises a third command and said controller is operable to cause said ballast to exit said programming mode upon receipt of said third command.

8. The electronic ballast of claim 1, wherein said infrared communication port comprises an infrared receiver.

9. The electronic ballast of claim 8, wherein said infrared communication port further comprises a lightpipe for facilitating the transmission of said infrared data signal from said infrared transmitter to said infrared receiver.

10. The electronic ballast of claim 9, wherein said lightpipe comprises a polyurethane tube.

11. The electronic ballast of claim 9, wherein said lightpipe comprises a THV terpolymer tube.

12. The electronic ballast of claim 8, wherein said infrared communication port further comprises a lens for facilitating the transmission of said infrared data signal from said infrared transmitter to said infrared receiver.

13. The electronic ballast of claim 1, wherein said infrared communication port is operable to receive a control signal from an infrared receiver external to said ballast and said control signal is representative of said infrared data signal.

14. The electronic ballast of claim 1, wherein said digital communication link is a DALI communication link.

15. A lighting control system, comprising:
an infrared transmitter, operable to transmit an infrared data signal;
a load control device, operable to control a lighting load and comprising a memory for storing an address; said load control device operable to receive a signal representative of said infrared data signal comprising said address and store said address in said memory; said load control devices adapted to be connected to a digital communication link.

16. The lighting control system of claim 15, wherein said signal representative of said infrared data signal comprises a first command and said load control device is operable to enter a programming mode upon receipt of said first command.

17. The lighting control system of claim 16, wherein said control device causes said lighting load to flash at a first rate after said device has entered said programming mode.

18. The lighting control system of claim 17, wherein said signal representative of said infrared data signal comprises a second command and said load control device is operable to enter an addressing mode upon receipt of said second command.

19. The lighting control system of claim 18, wherein said control device causes said lighting load to flash at a second rate after said device has entered said addressing mode.

20. The lighting control system of claim 19, wherein said second rate is faster than said first rate.

21. The lighting control system of claim 19, wherein said signal representative of said infrared data signal comprises a third command and said control device is operable to exit said programming mode upon receipt of said third command.

22. The lighting control system of claim 15, further comprising an infrared receiver, coupled to said ballast; said infrared receiver operable to receive said infrared data signal.

23. The lighting control system of claim 22, wherein said infrared receiver is operable to output to said ballast a control signal representative of said infrared data signal.

24. The lighting control system of claim 23, wherein said infrared receiver comprises a lightpipe for facilitating the transmission of said infrared data signal from said infrared transmitter to said infrared receiver.

25. The lighting control system of claim 23, wherein said infrared receiver comprises a lens for facilitating the transmission of said infrared data signal from said infrared transmitter to said infrared receiver.

26. The lighting control system of claim 15, wherein said load control device further comprises an infrared receiver, operable to receive said infrared data signal.

27. The lighting control system of claim 26, wherein said load control device further comprises a lightpipe for facilitating the transmission of said infrared data signal from said infrared transmitter to said infrared receiver.

28. The lighting control system of claim 26, wherein said load control device further comprises a lens for facilitating the transmission of said infrared data signal from said infrared transmitter to said infrared receiver.

29. The lighting control system of claim 15, further comprising said digital communication link and a plurality of load control devices are connected to said digital communication link, wherein eachsaid load control device has a unique address.

30. The lighting control system of claim 15, further comprising said digital communication link and a plurality of load control devices are connected to said digital communication link, wherein at least two of said load control devices have an identical address.

31. The lighting control system of claim 15, wherein said load control device is a ballast.

32. The lighting control system of claim 15, wherein said digital communication link is a DALI communication link.

33. A method of setting a link address for a device in communication with a control link from an infrared transmitter via infrared communication, comprising the steps of:
transmitting said link address from said infrared transmitter to said device; and
storing said link address in a memory of said device.

34. The method of claim 33, further comprising the step of:
causing said device to enter a programming mode by sending a first command from said infrared transmitter to said device, prior to transmitting said link address from said infrared transmitter to said device.

35. The method of claim 34, wherein said device is operable to control a lighting load, further comprising the step of:
causing said device to flash said lighting load at a first rate after said device has entered said programming mode.

36. The method of claim 35, further comprising the step of:
causing said device to enter an addressing mode by sending a second command from said infrared transmitter to said device, after said device has entered said programming mode.

37. The method of claim 36, further comprising the step of:
causing said device to flash said lighting load at a second rate after said device has entered said addressing mode.

38. The method of claim 37, wherein said infrared transmitter has a button, further comprising the step of:
pressing said button to select said link address before transmitting said link address from said infrared transmitter to said device.

39. The method of claim 38, further comprising the step of:
causing said device to exit said programming mode by sending a third command from said infrared transmitter to said device.

40. The method of claim 39, wherein said infrared transmitter has a plurality of buttons, further comprising the step of:
simultaneously pressing and holding a predetermined combination of more than one of said plurality of buttons for a predetermined period of time, before sending said third command.

41. The method of claim 37, wherein said second rate is faster than said first rate.

42. The method of claim 36, wherein said infrared transmitter has a button, further comprising the step of:
pressing said button before sending said second command.

43. The method of claim 34, wherein said infrared transmitter has a plurality of buttons, further comprising the step of:
simultaneously pressing and holding a predetermined combination of more than one of said plurality of buttons for a predetermined period of time, before sending said first command.

44. The method of claim 33, wherein a plurality of devices are connected to said control link and said link address is transmitted to at least two of said plurality of control devices.

45. A method of addressing a device in communication with a control link, comprising the steps of:
causing said device to select a random address, significantly larger than the maximum number of devices possible to be in communication with said control link;
ascertaining said random address of said device by performing a binary tree search method of the universe of possible random addresses;
transmitting to said device at said random address a short address, up to the maximum number of devices possible to be in communication with said control link; and
storing said short address in a memory in said device.

46. The method of claim 45, wherein a plurality of devices are in communication with said control link and said binary tree search method further comprises the steps of:
(a) ascertaining if said random address of said device is within a subset of possible random addresses;
(b) reducing said subset of possible random addresses; and
(c) repeating steps (a) and (b).

47. A method of assigning a device having a device address to a group from a user interface of a master lighting control unit having a memory, wherein both said device and said master lighting control unit are in communication with a control link, said method comprising the steps of:
selecting said device address using said user interface of said master lighting control unit;
selecting said group using said user interface; and
storing an assignment of said device address to said group in said memory of said master lighting control unit.

48. The method of claim 47, further comprising the step of:
displaying said device address on a first display on said user interface.

49. The method of claim 48, wherein selecting said device address using said user interface further comprises the step of:
pressing a button on said user interface.

50. The method of claim 49, wherein said device is a load control device coupled to a lighting load, further comprising the step of:
causing said device to flash said lighting load after selecting said device address using said user interface.

51. The method of claim 50, wherein selecting said group comprises:
pressing a zone assign button on said user interface.

52. The method of claim 51, further comprising the step of:
lighting a second display on said user interface after selecting said group to provide a visual indication that said group was selected.

53. The method of claim 52, further comprising the step of:
pressing a zone unsassign button on said user interface; and
deleting said assignment of said device address to said group from said memory.

54. The method of claim 50, wherein said device flashes said lighting load at a rate of one flash per two seconds.

55. The method of claim 48, wherein said first display is a seven-segment display.

56. The method of claim 47, further comprising the step of:
causing said master lighting control unit to enter a programming mode before selecting said device address using said user interface.

57. The method of claim 56, further comprising the step of:
causing said master lighting control unit to exit said programming mode.

58. The method of claim 57, wherein said user interface comprises a plurality of buttons and wherein causing said master lighting control unit to exit said programming mode comprises:
simultaneously pressing and holding a predetermined combination of more than one of said plurality of buttons for a predetermined period of time.

59. The method of claim 56, wherein said user interface comprises a plurality of buttons and wherein causing said master lighting control unit to enter said programming mode comprises:
simultaneously pressing and holding a predetermined combination of more than one of said plurality of buttons for a predetermined period of time.

60. A master lighting control unit, comprising:
a controller;
a user interface, coupled to said controller;
a digital communication port, coupled to said controller and operable to be connected to a digital communication link having a control device also connected thereto; said control device having an address; and
a memory, coupled to said controller and operable to store said address of said control device;
wherein said controller is operable to:
cause said control device to choose a random address, significantly larger than the maximum number of devices possible to be in communication with said digital communication link;
ascertain said random address of said control device by performing a binary tree search method of the universe of possible random addresses; and
transmit to said control device at said random address a short address, up to said maximum number of devices possible to be in communication with said digital communication link.

61. The master lighting control unit of claim 60, wherein said digital communication link is a DALI communication link.

62. A master lighting control unit, comprising:
a controller;
a user interface, coupled to said controller;
a digital communication port, coupled to said controller and operable to be connected to a digital communication link having a control device also connected thereto; said control device having an address; and
a memory, coupled to said controller and operable to store said address of said control device;
wherein said controller is operable to:
select said address of said control device;
select a group; and
store an assignment of said address of said control device to said group in said memory.

63. The master lighting control unit of claim 62, wherein said address of said control device is selected based on an input from said user interface.

64. The master lighting control unit of claim 62, wherein said group is selected based on an input from said user interface.

65. The master lighting control unit of claim 62, wherein said digital communication link is a DALI communication link.
